(19) United States
(12) Patent Application Publication
(10) Pub. No.: US 2026/0117389 A1
(43) Pub. Date: Apr. 30, 2026

(54) METHOD AND APPARATUS FOR COLD SPRAY REPARATION OF REACTIVE METAL SURFACES

(71) Applicant: Hatch Ltd., Mississauga (CA)

(72) Inventors: Sima AHMAD ALIDOKHT, Montreal (CA); Richard CHROMIK, Montreal (CA); Murray PEARSON, Mississauga (CA)

(21) Appl. No.: 19/128,820

(22) PCT Filed: Nov. 9, 2023
(86) PCT No.: PCT/CA2023/051495

§ 371 Date: May 9, 2025

Related U.S. Application Data
(60) Provisional application No. 63/424,657, filed on Nov. 11, 2022.

(51) Int. Cl. C23C 24/04; C23C 30/00

(52) U.S. Cl. CPC C23C 24/04; C23C 30/00

(57) ABSTRACT

A method for resurfacing a reactive metal surface using a cold spray coating of reactive metal particles. The particles comprise a non-spherical morphology and properties similar to or the same as the reactive metal surface needing repair. The particles may be accelerated to undergo plastic deformation to cause the particles to bond to the reactive metal surface. The bonded particles form a repaired reactive metal surface that is continuous with the existing reactive metal surface.

### FIELD

The present invention relates to thermal spray technology and more specifically to reparation of reactive metal components and protective coatings.

### BACKGROUND

Reactive metals have been used in many industrial applications, including in power, mining, oil and gas and chemical sectors. The most common reactive metals include titanium, zirconium, niobium, and tantalum. In an example, valves used to regulate flow of materials such as liquids, gases and slurries in industrial applications comprise components that include reactive metals. One example valve is a metal-seated ball valve (MSBV).

MSBV's and other industrial equipment constructed of reactive metals with hard metal oxide coatings may be used for example in hydrometallurgical plants where severe service conditions exist. Severe service conditions may include conditions involving high pressures, temperatures and/or aggressive chemicals. For example, hydrometallurgical plants may include high-pressure acid leaching circuits and/or pressure oxidation autoclave circuits with components that comprise, for example, reactive metals, and sometimes coated with hard reactive metal oxides or ceramics. Failure of these components, for example, the failure of a valve to isolate a process vessel, is particularly dangerous in these aggressive and toxic environments as it may potentially harm workers in the space or cause damage to surrounding structures or equipment.

In an example, severe-service MSBVs may be employed in operating conditions involving high pressure, high temperature, and/or highly corrosive environments. The ball and seats making up the MSBV's may be manufactured for example from forged Inconel™ Alloy 718 PH, super duplex stainless steel alloys, and various grades of titanium including grades 2, 3, 4 or 12. To extend the in-service life of these components, valve sealing surfaces may be coated with a wear resistant thermally sprayed hard oxide or ceramic coating including TiO₂, Cr₃C₂, Cr₂O₃, or Al₂O₃. Nevertheless, valve failure may still be caused by sealing surface degradation. For example, failures may include: (1) valve failure to cycle open or closed owing to excessive friction between the sealing surfaces; and (2) valve failure to isolate due to flaws in the sealing surfaces. Sealing surface degradation may for example be caused by wear mechanisms including plastic deformation, abrasion, erosion, galling, and spallation. These wear mechanisms may be further combined with corrosion, for example corrosion caused by H₃O⁺, S²⁻, Cl⁻ or F⁻ ions in the solution or by entrapped solid particles (FeS, Fe₂S, FeAsS) that exist in flow between the sealing surfaces. Although the example provided above relates to valves, and specifically MSBVs, many other industrial applications and articles have a similar reactive metal protective coating, and sometimes a hard metal oxide or ceramic coating on the reactive metal surface.

Components of ball valves in high wear environments have previously been repaired in one of two ways depending on the extent of the damage. Where the ball valve damage depth is only up to a few hundred microns and therefore only affecting the coating, machining and redepositing conventional thermal spray coating is used. For more severe damage that extends into the forged metals, the ball or seat components need to be re-melted and remanufactured. Extended damage in these components therefore poses significant costs for repair and delays in manufacture processes as the components are remanufactured. In most cases, the damaged component is simply replaced with a new component as this may be more cost effective than remanufacture, and the damaged components are returned to the foundry as scrap metal.

### BRIEF DESCRIPTION OF THE FIGURES

FIG. 1 is a schematic of an apparatus for performing a method for restoring a protective coating, repairing a damaged surface, or rebuilding an eroded wear surface of industrial equipment, as described in this disclosure.

FIG. 2 shows an example of a ball valve failure due to erosion.

FIG. 3 shows an example of spalling of the ceramic coating failure on a ball of a ball valve.

FIG. 4 shows an example of a ball valve failure due to flashing (i.e. wire draw).

FIG. 5 shows a blocky morphology of a reactive metal powder and its microstructure.

FIG. 6 shows a coral-like morphology of a reactive metal powder and its microstructure.

FIG. 7 shows an example of a coating made by spraying blocky particle morphology in accordance with an embodiment of the invention.

FIG. 8 shows an example of a coating made by spraying coral-like particle morphology in accordance with an embodiment of the invention.

FIG. 9 shows an example of metal seated ball valve components that may be resurfaced according to methods as described herein.

### DETAILED DESCRIPTION

In an aspect, the present disclosure provides a method for resurfacing a damaged reactive metal surface using a cold spray coating of reactive metals. Resurfacing damaged metals may include, for example restoring a protective coating on a substrate, repairing or rebuilding an eroded or damaged wear surface comprising reactive metal. The method may be used to repair damage that otherwise could not be fixed by conventional means such as welding or weld overlay. The methods and apparatus herein described are applicable to any number of surfaces, substrates or components comprising or covered by a reactive metal (broadly referred to herein as reactive metal surfaces) such as for high wear environments.

Cold spray is a solid-state deposition process in which a high velocity (for example, 300-1200 m/s) jet of particles impacts a surface. The particles in the cold spray process are accelerated in a spray gun nozzle in conjunction with a pressurized gas. By contrast to thermal spray processes (as further discussed below), cold spray uses lower temperature spray and a higher velocity spray.

In an aspect, the method comprises providing an inert gas and reactive metal particles in powder form and heating the particles to a threshold temperature that is less than the melting point of the particles. Gas with the metal particles entrained therein is emitted from a nozzle at a select velocity to accelerate the particles to a threshold velocity while maintaining the solid state of the particles. The particles may be directed at a reactive metal surface, for example a reactive base metal surface of a substrate and/or at an existing wear-resistant protective coating comprising a reactive metal. On impact, the particles plastically deform to bond to the base metal and/or the existing protective coating to form a repaired reactive metal surface that is continuous with the existing reactive metal surface (i.e. continuous with the reactive base metal or with the wear resistant protective coating, when present). The reactive metal particles may be in a powder form and may be non-spherical.

Upon impact with the target surface, the particles undergo severe plastic deformation. The plastic deformation may lead to bonding of the particles to each other and the impact surface, and may further result in coating buildup. The gas temperature is maintained below the melting points of the particles such that the particles remain in a solid-state. This method may have distinct advantages and unique applications over thermal spray processes due to its operation at low temperatures (for example, temperature below the melting point of the particles). Thermal spray coating deposition processes includes plasma spray, arc spray, flame spray, and high velocity oxy-fuel (HVOF) spray. Thermal spray processes use molten or semi-molten droplets of material, for example metals, ceramics and polymer materials, that are heated and deposited onto a surface. These processes have been used in the aerospace, shipping, oil and gas and mining industries and can be used to form coatings on materials. Unlike a thermal spray process, a cold spray process reduces or eliminates detrimental phase transformation, oxidation, or decarburization of powders, and thus, the method may be suitable for heat-sensitive feedstock materials. Reactive metals are highly reactive and if they reach their melting temperature, they need to be fully enveloped (shielded) by inert gases within an ultra-clean working environment. Furthermore, impact-induced high strains and the heat generated in a conventional thermal spray process may cause partial or complete recrystallization and evolution of ultra-fine microstructure which may be detrimental to the coating hardness or toughness. The continuous high-velocity impact of particles in the cold spray process as disclosed herein may produce a shot-peening and tamping effect, which may result in densification and deposition of coating with nearly theoretical density (i.e. the bulk density of a material with no porosity and stoichiometric composition). Moreover, spray coatings according to this disclosure may have residual compressive stresses and a hardening effect due to high-velocity impact and plastic deformation of the surface layer.

Resurfacing the surface according to this disclosure may require a dense coating, for example comprising a porosity of less than about 1%. The coating may also require high adhesion strength in order to accommodate larger repair surface areas or greater thicknesses, for example greater than about 2-3 mm, and coating delamination caused by residual stress buildup. Resurfacing a reactive metal surface with a pre-existing protective coating on top of forged or cast metal of the same or different material, may be accomplished by methods according to this disclosure. In an example, the method of resurfacing the reactive metal surface comprises binding particles of metal with the existing margins of the protective coating such that the repair results in a continuous protective coating. Any one or more of the following process parameters: (1) powder or particle morphology, (2) cold spray apparatus, (3) nozzle or spray gun traverse velocity and powder feed rate, (4) gas temperature and pressure, (5) wear surface preparation, and (6) surface preheating, as further described herein, may be adjusted or modified in order to influence the resurfacing.

In the methods as described herein, the particles remain in a powder solid state throughout the cold spray process and deform plastically on impact with the target surface. The particles comprise a non-spherical morphology. The inventors have discovered that use of spherical morphology particles does not achieve the desired resurface characteristics such as density and porosity. For example, the particles may have a morphology of one or more of angular, blocky, and coral-like forms. The particles may comprise an equiaxed microstructure such that the dimensions in all directions are approximately equal. In an example, the particle grain sizes may vary from hundreds of nanometers to a few microns. In comparison to spherical particles, the non-spherical morphology may display coatings with lower porosity, higher hardness and higher deposition efficiency. Without intending to be bound to a particular theory, the non-spherical particle morphology may result in a greater aerodynamic drag coefficient, and therefore such particles may achieve an actual particle velocity that is closer to the gas velocity. A higher particle velocity can give rise to a higher kinetic energy which is favorable, for example, for deposition of a dense, uniform, non-porous coating. In addition these non-spherical particles may comprise higher deformability caused by the higher particle velocity, specific surface area and initial equiaxed microstructure.

The particles comprise reactive metals. For example, the particles may comprise titanium powder or alloys thereof. For example, the particles may comprise commercial purity titanium-grades 1, 2, or 4, or palladium-stabilized titanium (Ti—Pd) alloy grades 7, 11, 16, or 17, or ruthenium-stabilized titanium (Ti-0.1Ru) grade 27. Alternatively or additionally, the particles may comprise any one or more other reactive metals such as zirconium, niobium, tantalum, or any alloys thereof.

Methods as disclosed herein may include a cold spray apparatus, such as for example a spray gun or other nozzle configuration adjusted to emit accelerated particles entrained in a gas towards a pure or alloyed grade reactive metal surface requiring repair. The cold spray apparatus, for example the spray gun, may be mounted about 40 mm from the surface requiring repair. The distance of the cold spray apparatus from the surface however may be more or less than 40 mm depending on the powder used (for example, the powder material and size), as well as tuned according to the type of cold spray apparatus to increase effectiveness. For example, setting a cold spray apparatus nozzle too close to a surface may cause bow shock (i.e. a region of recirculating, high-density, low-velocity gas) that may negatively influence particle deposition. Further, taking a cold spray nozzle too far from a surface may result in particles losing velocity when interacting with air and affecting the effectiveness of the cold spray. The nozzle may be a converging-diverging nozzle, for example a nozzle having an hourglass converging-diverging shape (also known as a de Laval nozzle). In an example, a commercially available Plasma Giken PCS-1000 spray gun comprising a de Laval nozzle made of WC—Co may be used. In another example, a commercially available Cold Gas Technology (CGT) Germany Kinetik 4000, spray gun with a de Laval nozzle made of SiC and a preheating chamber may be used.

The gases used for entraining the metal particles may be compressed air or any one or more compressed gases such as for example nitrogen or helium (referred to herein as a “carrier gas”). The carrier gas may be preheated. In an example, the carrier gas may be preheated to a temperature of between about 710° C. and about 950° C., for example about 750° C. to about 900° C., or for example about 800° C. to about 850° C. The gas may be pressurized between about 4 M Pa(g) to about 3.5 M Pa(g), for example the gas supply pressure may be about 3.5 M Pa(g), or about 3.75 M Pa(g), or about 4 M Pa(g).

A desired combination of metal particle powder feed rate and spray gun traverse velocity may be selected to promote coating adherence to the reactive metal surface. The spray gun traverse velocity is the velocity at which the spray gun nozzle travels along a path to complete 1 pass across the surface to be resurfaced. For example, the spray gun traverse velocity may be about 10 mm/s to about 600 mm/s, for example about 30 mm/s to about 400 mm/s, or about 100 mm/s to about 300 mm/s. Variation in the metal particle powder feed rate and/or the spray gun traverse velocity may be balanced to control and reach a certain coating thickness per pass. For example, a coating comprising a thickness of at least about 2 millimeters, or at least about 3 mm, or at least about 5 mm may be obtained by adjusting the powder feed rate and/or spray gun traverse velocity. A feed rate that is too high may increase the risk of nozzle clogging by deposit buildup in the nozzle throat and walls. A low feed rate may enhance heat build-up and temperature of the surface and eventually lead to higher deformation of powders, however, it can cause oxidation of the surface and may deteriorate the particles/surface adhesion properties.

The particle feed rate, or the rate at which the particles are entrained into the gas, may be between about 1.5 g/min and about 60 g/min, for example between about 10 g/min and about 56 g/min, or for example between about 15 g/min and about 35 g/min, or for example between about 20 g/min and about 30 g/min. The particles entrained in the gas may be accelerated in the gas flow.

A base metal or reactive metal surface on to which the particles are sprayed may comprise a pure or alloyed grade of reactive metal similar to or the same as the grade of reactive metal of the particles. In an example, the wear-resistant protective coating may similarly comprise a pure or alloyed grade of reactive metal that is the same as or is similar to the grade of reactive metal of the particles. The protective coating material may be different than the underlying base metal material. The base metal for example may comprise rolled metal, wrought metal, forged metal or cast metal. In an example, an additional ceramic or oxide coating may be applied to the reactive metal surface after repair, or to the wear resistant protective coating. The ceramic or oxide coating may comprise Cr₂O₃, TiO₂, or other hard metal oxides. The ceramic oxide coating may be applied using thermal spray processes such as Air Plasma Spray (APS) or the High-velocity Oxy-fuel (HVOF).

The reactive metal surface requiring resurfacing may be first prepared by roughening the surface. Particle/surface mechanical anchoring and coating adhesion may be improved by roughening the surface before spray coating. In instances where grit may become embedded in the surface, the surface may be further prepared by grit blasting. Grit blasting, for example using a high pressure or low pressure grit blaster, may be performed for example at an angle of 45° to surface normal. After grit blasting, the surface may be cleaned by brushing and/or air blasting to remove residual grit blasting media from the surface. In other examples, the wear surface may be further prepped using laser surface structuring and ablation and/or grinding and machining. Laser ablation and laser surface structuring is particularly useful for preparing damaged surfaces with crevices, craters, small indentations or other surface features that cannot be practically removed by grinding or machining due to the geometry of the defect.

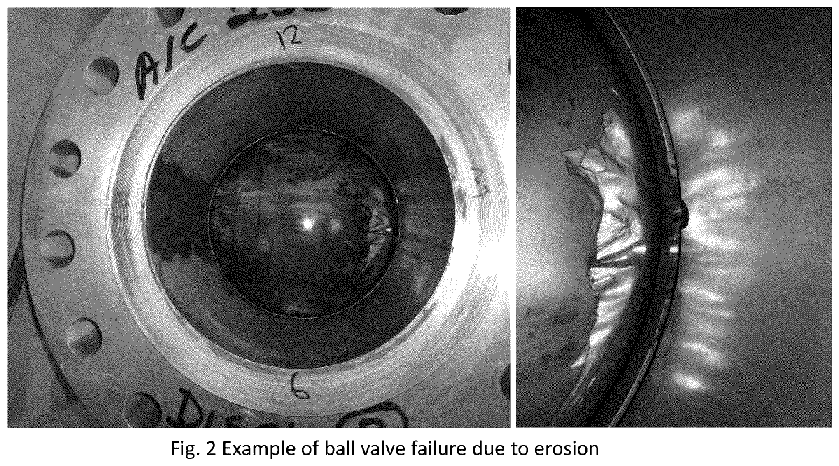

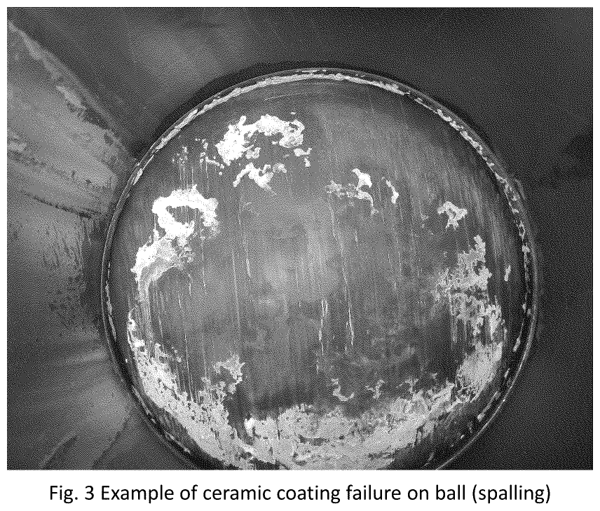

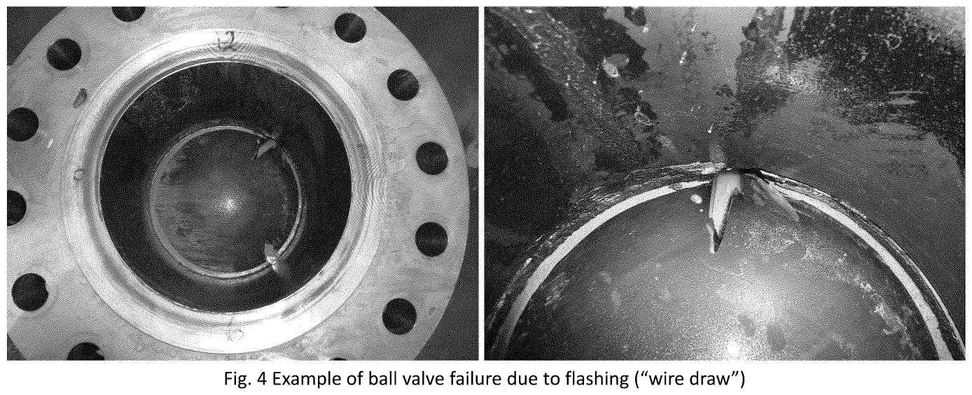

Equipment wear surfaces comprising a reactive metal surface requiring repair may be a component of a larger assembly or equipment. In an example, the equipment may be constructed of a composite of two different metals, comprising a reactive base metal substrate and a protective wear-resistant coating. In another example, the reactive metal surface may be constructed of a composite of two or more different metals, for example three metals, and may comprise a reactive base metal substrate, a ductile interlayer, and a wear-resistant protective coating. The equipment requiring repair may be for example, the interior surface of a metal-clad autoclave, metallurgical or chemical process vessel, a metal-clad nozzle cover, a metal-clad reducing flange, or a metal-seated ball valve. The damage on the reactive metal surface may be limited to erosion of the protective layer, or the damage may extend deeper into the reactive metal surface, for example including erosion of the ductile interlayer when present and/or the reactive base metal layer. FIG. 2 shows an example ball valve failure due to erosion. Other examples of surface wear include coating spalling as shown in FIG. 3, wire draw as shown in FIG. 4, cavitation wear, and impingement wear. Damaged areas in the protective layer may be defined by a void in the protective layer that exposes the underlying metal. In the resurfacing process as described herein, the sprayed particles can adhere to the protective coating margins defining the void to form a continuous repaired protective coating. In further examples, the particles may additionally bind to an underlying reactive metal layer below the protective coating. For example, the particles may bind to both the substrate base metal and the protective coating, or to the base metal, ductile layer and protective coating, provided each of them is compatible with the metal powder. Since metal powders do not bind to oxide coatings, such oxide coatings, if present, may be removed (for example, if damaged) or masked during repair processes to allow metal powders to bind to the reactive metal surface or wear resistant coating to restore the surface or wear coating to a like-new condition. An oxide or ceramic coating may be re-added as a top layer in a further step using thermal spray processes if desired.

Preheating the reactive metal surface before particle deposition on the surface may promote strong coating to surface bonding. This is due to the softening effect of the surface which leads to its intense plastic deformation and resulting mechanical interlock once the first layer of particle coating is deposited. In addition, severe plastic deformation of the softened surface may help create a more oxide-free interface which can then provide intimate contact between sprayed particles and surfaces and may enhance the likelihood of metallurgical bonding occurrence. In an example, a jet gas at a relatively low traverse speed may be used to preheat the surface. In another example, a heating stage may be used to preheat the surface. For example, the surface may be preheated immediately before coating deposition using a jet gas of 800° C. with a spray gun traverse speed of 200 mm/s (1 or 2 passes) and 50 mm/s (1 or 2 passes).

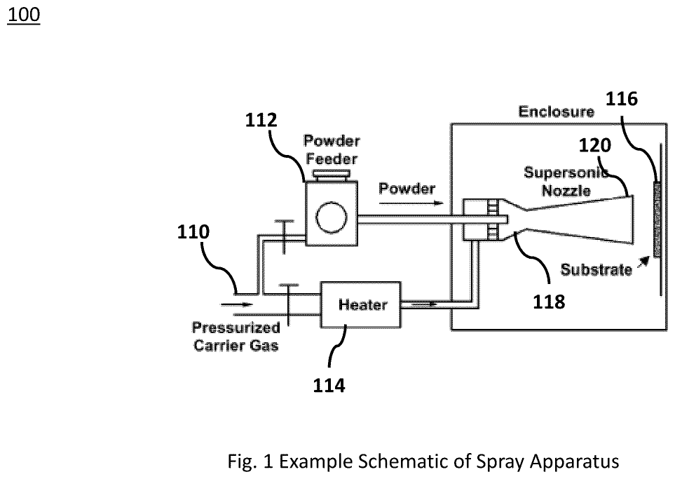

FIG. 1 provides a schematic diagram 100 comprising an apparatus for performing the method described herein for restoring a protective coating, repairing or rebuilding an eroded or damaged wear surface of industrial equipment. A pressurized gas reservoir 110 supplies a pressurized carrier gas, such as air, nitrogen or helium to an electric heater 114 to increase and control the gas temperature to between about 710° C. and about 950° C. The pressurized carrier gas, supplied at a pressure of between about 3.5 M Pa(g) and about 4 M Pa(g) is also directed towards a powder feeder 112. The powder feeder 112 comprises non-spherical powder particles of reactive metal. The particles are preferably of the same or similar reactive metal of the equipment 116 to be repaired, restored or rebuilt. The powder and gas converge at the cold spray apparatus 118, for example at the spray gun, such that the particles become entrained in the gas. The temperature of the particles is increased to below a melting point of the particles due to the heated gas. The particles are then accelerated to supersonic velocities in the nozzle 120 of the spray gun in conjunction with the pressurized and preheated gas. Just before spraying the equipment surface 116, the surface is grit blasted and may be preheated (not pictured). The particles are then directed towards the surface and plastically deform on impact leading to bonding and coating buildup.

### Examples

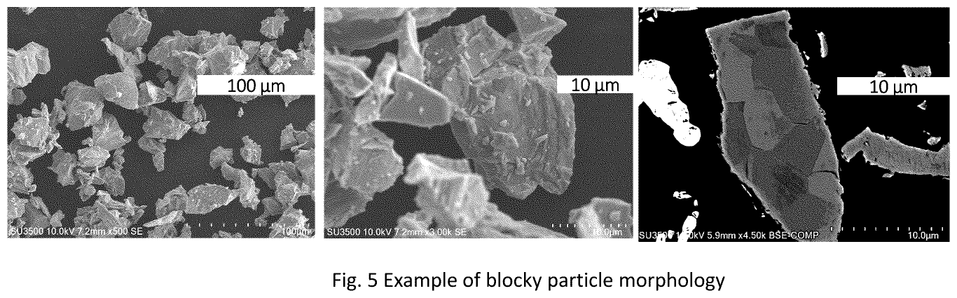

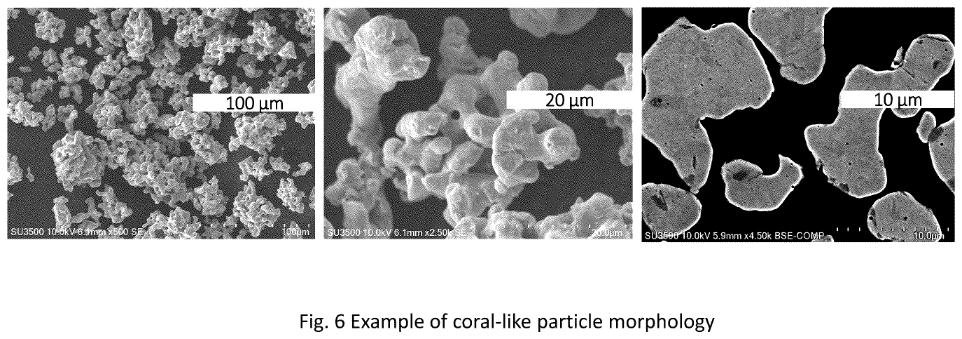

In an example test, two non-spherical powder morphologies were tested. The first obtained from Oerlikon Metco, Switzerland comprising a blocky morphology as shown in FIG. 5 and the second obtained from Cristal Metals, USA comprising a coral-like morphology as shown in FIG. 6. Both commercially available Plasma Giken and Kinetik 4000 spray guns were used for testing. On the Plasma Giken equipment, the gas pressure was 4 MPa and the gas preheat temperature was 800° C. and 950° C. prior to entering the nozzle. For Kinetik 4000, the following sets of gas supply pressure and gas preheat temperature conditions were used: 720° C.-760° C. at 4 MPa and 800° C.-3.5 MPa.

Using the Plasma Giken spray apparatus, each of the two titanium grade 4 powder morphologies were sprayed using 3 passes (with a thickness of ˜1 mm). After comparing the two morphologies using the same process conditions, observations showed the blocky morphology powder led to lower porosity, however the coral-like morphology still provided acceptable porosity. For both coatings, grit inclusions were observed at the coating/surface interface which could reduce adhesion strength. For blocky powder, smaller grit was also tested which led to lower inclusion of grit particles.

The blocky powder was also sprayed using the CGT Germany Kinetik 4000 spray apparatus using two gas parameters, i.e. 720° C. at 4 MPa and 800° C. at 3.5 MPa, using 3 passes. A significantly lower porosity was measured for both, with an even lower value for the latter condition. Using the same spray condition, coatings were sprayed using 12 passes with a thickness of 5.6 mm. Coating porosity and grit inclusion remained significantly low. However, due to the buildup of residual stresses, in some cases, coatings were found to be delaminated upon removing the sample from the holder.

Two other parameters were then tested including surface preheating using a gas jet before feeding powders into the nozzle as well as a much lower thickness per pass using a higher gun traverse speed.

Surface preheating was performed using a gas jet with gun traverse speeds of 200 mm/s and 50 mm/s. This was tested with and without reducing the thickness per pass by increasing the gun speed to 500 mm/s. Surface preheating and reducing the coating thickness per pass were effective in reducing the residual stresses to a point where coatings were not delaminated upon removing.

In order to help improve adhesion, a lower feed rate was then tested with a lower gun traverse speed while maintaining surface preheating and reducing the thickness per pass. This led to an adherent coating that withstands mechanical stresses from removal from the holder and cutting and it stayed adherent to the surface.

Tables 1 and 2 below shows the powders, process parameters and coating characteristics of various tests according to methods as previously described.

TABLE 1
Powders and Process Parameters

| | | | | | Preheating | | | | | |
|---|---|---|---|---|---|---|---|---|---|---|
| | | | | Substrate/ | (gun | | | | | |
| | | Surface | | Surface | traverse | | | | Gun | |
| Spray | | preparation | Spray | dimension | speed | Gas preheat | Gas | Feed rate | traverse speed | Number |
| Run | Powder | (grit size) | system | (inches) | mm/s) | temperature (° C.) | pressure (MPa) | (g/min) | (mm/s) | of passes |
| #1c | Ti (coral) | Grit-24 | PG-LW | 3 × 1 | — | 800 | 4 | 56 | 200 | 3 |
| #2c | Ti (coral) | Grit-24 | PG | 3 × 1 | — | 950 | 4 | 56 | 200 | 3 |
| #3c | Ti (coral) | Grit-24 | PG-LW | 3 × 1 | — | 800 | 4 | 56 | 200 | 8 |
| #4c | Ti (coral) | Grit-24 | PG-LW | coupons | — | 800 | 4 | 56 | 200 | 8 |
| | | | | 1 inch | | | | | | |
| | | | | diameter | | | | | | |
| #5c | Ti (coral) | Grit-24 | PG | 3 × 1 | — | 800 | 4 | 20 | 200 | 3 |
| #6c | Ti (coral) | Grit-24 | PG | 3 × 1 | — | 800 | 4 | 20 | 200 | 6 |
| #7c | Ti (coral) | Grit-24 | PG | 3 × 1 | — | 800 | 4 | 20 | 600 | 12 |
| #1b | Ti | Grit-24 | PG | 3 × 1 | — | 800 | 4 | 35 | 200 | 4 |
| | (blocky) | | | | | | | | | |
| #2b | Ti | Grit-60 | PG | 3 × 1 | — | 800 | 4 | 20 | 200 | 5 |
| | (blocky) | | | | | | | | | |
| #3b | Ti | Grit-60 | CGT | 3 × 1 | — | 720 | 4 | 25 | 200 | 3 |
| | (blocky) | | | | | | | | | |
| #4b | Ti | Grit-60 | CGT | 3 × 1 | — | 800 | 3.5 | 25 | 200 | 3 |
| | (blocky) | | | | | | | | | |
| #5b | Ti | Grit-60 | CGT | coupons | — | 800 | 3.5 | 25 | 200 | 3 |
| | (blocky) | | | 1 inch | | | | | | |
| | | | | diameter | | | | | | |
| #6b | Ti | Grit-60 | CGT | 3 × 3 | — | 800 | 3.5 | 25 | 200 | 12 |
| | (blocky) | | | | | | | | | |
| #7b | Ti | Grit-60 | CGT | 3 × 3 | 200-1 pass | 800 | 3.5 | 25 | 200 | 12 |
| | (blocky) | | | | | | | | | |
| #8b | Ti | Grit-60 | CGT | 3 × 1 | — | 800 | 3.5 | 10 | 500 | 20 |
| | (blocky) | | | | | | | | | |
| #9b | Ti | Grit-60 | CGT | 3 × 1 | — | 800 | 3.5 | 29 | 500 | 30 |
| | (blocky) | | | | | | | | | |
| #10b | Ti | Grit-60 | CGT | 3 × 3 | 50-2passes | 800 | 3.5 | 29 | 500 | 20 |
| | (blocky) | | | | | | | | | |
| #11b | Ti | Grit-60 | CGT | 3 × 3 | 50-2passes | 800 | 3.5 | 10 | 250 | 36 |
| | (blocky) | | | | | | | | | |

TABLE 2
Coating Characteristics

| | Deposition | Thickness | Porosity | Porosity | Adhesion | |
|---|---|---|---|---|---|---|
| Spray | efficiency (%) | (mm) | Within passes (%) | Between passes (%) | strength (ksi) | Adhesion-qualitative |
| #1c | 82 | 0.9 | 9 | 1.7 | | adherent |
| #2c | 70 | 1.1 | 10 | 1.2 | | adherent |
| #3c | 82 | 4.5 | 9 | 1.7 | | adherent |
| #4c | — | 4.5 | 9 | 1.7 | 2.7 ± 0.5 | adherent |
| #5c | 88 | 4.5 | 10 | 5 | | spalled |
| #6c | 85 | 5 | 10 | 5 | | spalled |
| #7c | 90 | 5 | 1.7 | 1.1 | | adherent |
| #1b | 55 | 0.9 | 2.2 ± 0.7 | 2.2 ± 0.7 | | Adherent-Interface grits |
| #2b | 60 | 1 | 2.6 ± 0.5 | 2.6 ± 0.5 | — | Adherent-No grit |
| #3b | 75 | 1.1 | 0.07 ± 0.03 | 0.07 ± 0.03 | — | Adherent-No grit |
| #4b | 99 | 1.3 | 0.02 ± 0.01 | 0.02 ± 0.01 | — | Adherent-No grit |
| #5b | 99 | 1.3 | 0.02 ± 0.01 | 0.02 ± 0.01 | 5 ± 2 | Adherent-No grit |
| #6b | 99 | 5.6 | 0.02 ± 0.01 | 0.02 ± 0.01 | — | Coating spallation |
| #7b | 99 | 5.8 | 0.02 ± 0.01 | 0.02 ± 0.01 | — | Coating spallation- after |
| | | | | | | cutting |
| #8b | 99 | 1.9 | 0.01 | 0.01 | — | Adherent-No grit |
| #9b | 99 | 3.1 | 0.01 | 0.01 | — | Adherent-No grit |
| #10b | 99 | 5.3 | 0.01 | 0.01 | — | Coating spallation |
| #11b | 99 | 4.9 | 0.01 | 0.01 | >9 ± 1 | Adherent-No grit |

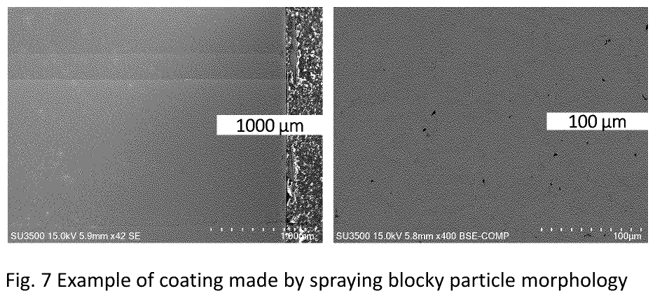

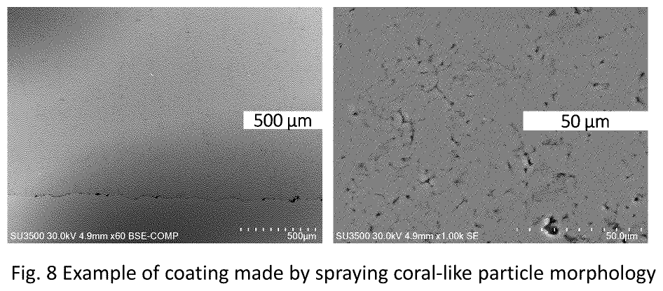

The process parameters may be adjusted based on the specific equipment surface or substrate surface to be repaired, restored or rebuilt. In Table 2, above, the tests where the coating was adherent were considered successful. Those tests which resulted in coating spallation were considered unsuccessful depositions and the process parameters were adjusted. In test 1b, although the coating was adherent, there resulted some grit at the coating interface. Accordingly, the remaining tests were conducted with smaller sized grit to help avoid grit at the interface. FIG. 7 shows an example coating at 1000 μm magnification and at 100 μm magnification, made by spraying blocky particle morphology according to an embodiment of this disclosure. FIG. 8 shows an example coating at 500 μm magnification and at 50 μm magnification, made by spray coating coral-like particle morphology according to an embodiment of this disclosure.

In an example, the resurfacing method as disclosed herein may be used to restore a pre-existing protective coating on a surface. The protective coating may be formed of the same, similar or different metal than an underlying base layer forming the substrate. In another example, the resurfacing method may be used to repair a damaged substrate base layer followed by restoration of an outer protective coating. In yet another example, the resurfacing method may be used to rebuild an eroded wear surface of industrial equipment, including both an eroded coating layer and base layer.

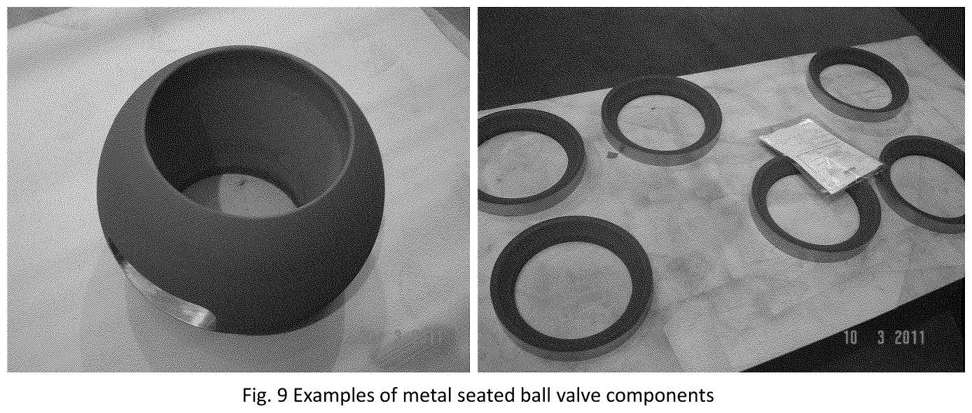

Representative examples of components or equipment with reactive metal wear surfaces that can be repaired, restored or rebuilt using the resurfacing method described herein include: forged balls, seats and stems of metal seated ball valves for example such as those components shown in FIG. 9; interior or exterior surfaces of forged or cast valve bodies; composite spargers as described in U.S. Pat. Nos. 7,968,048 and 7,976,774, which are incorporated herein by reference; vortex finders, apex cones and wear inserts for gas cyclones; dip pipes for introduction and/or removal of process slurry from metallurgical equipment; agitator impellers or turbine discs and blades; interior surfaces of a metal-clad autoclave, metallurgical or chemical process vessel, a metal-clad nozzle cover, or a metal-clad reducing flange; compartment walls, anti-swirl baffles, support of dip pipes, spargers and other internal devices for autoclaves and metallurgical or chemical reactors; apparatus for deceleration of supersonic flow as described in U.S. Pat. No. 8,176,941, which is incorporated herein by reference; and, devices for pressure letdown as described in U.S. Pat. No. 8,670,958 and related U.S. patent application Ser. Nos. 09/895,039 and 11/127,918, which are incorporated herein by reference.

It is to be understood that the above described embodiments of the invention and representative examples are merely illustrative of numerous and varied other embodiments, which may constitute applications of the principles of the invention. Such other embodiments and applications may be readily devised by those skilled in the art without departing from the spirit or scope of this invention and it is the inventor's intent that such derivatives are deemed as within the scope of this invention.

Although the invention has been described in connection with certain embodiments, it is not limited thereto. Rather, the invention includes all embodiments which may fall within the scope of this disclosure.

We claim:

1. A method for resurfacing a reactive metal surface, the method comprising:
providing a carrier gas;
providing reactive metal particles in a powder form, the particles having a non-spherical morphology;
heating the reactive metal particles to a threshold temperature that is less than the melting point of the particles;
emitting the gas from a nozzle at a select gun traverse velocity, and entraining the reactive metal particles in the gas to accelerate the particles to a threshold velocity that maintains the particles in a solid-state within the gas;
directing the accelerated particles at the reactive metal surface, wherein the reactive metal surface comprises a pure or alloyed grade of reactive metal similar to or the same as the grade of reactive metal of the particles;
contacting the reactive metal surface with the accelerated particles to cause the particles to undergo plastic deformation to bond the particles to the reactive metal surface to form a repaired reactive metal surface that is continuous with an existing reactive metal surface.

2. The method of claim 1, wherein the carrier gas is compressed air or one or more of a nitrogen, or helium gas.

3. The method of claim 1, wherein the carrier gas is preheated to a temperature of between 720 and 950 degrees Celsius at a supply pressure of between 3.5 M Pa(g)] and 4 M Pa(g).

4. The method of claim 1, wherein the gun traverse velocity is between 200 and 600 millimeters per second.

5. The method of claim 1, wherein the particles are entrained in the carrier gas at a rate of between 10 grams per minute and 56 grams per minute.

6. The method of claim 1, wherein the particles are titanium powder.

7. The method of claim 1, wherein the particles are commercial purity titanium grades 1, 2, or 4, or palladium-stabilized titanium (Ti—Pd) alloy grades 7, 11, 16, or 17, or ruthenium-stabilized (Ti-0.1Ru) alloy grade 27.

8. The method of claim 1, wherein the particles are composed of one or more of other reactive metals such as zirconium, niobium, tantalum, or alloys thereof.

9. The method of claim 1, wherein the particles have a morphology of one or more of angular, blocky, and coral-like forms.

10. The method of claim 1, wherein the particles comprise an equiaxed microstructure.

11. The method of claim 1, wherein the particle size is between hundreds of nanometers to a few microns.

12. The method of claim 1, further comprising heating the reactive metal surface prior to contacting with the accelerated particles.

13. The method of claim 1, wherein the reactive metal surface forms a part of a component or equipment, such as a metal-seated ball valve.

14. The method of claim 1, wherein the reactive metal surface is a corrosion-resistant reactive metal layer.

15. The method of claim 1, wherein the reactive metal surface is composed of a ductile interlayer between a protective coating and a reactive base metal.

16. The method of claim 1, wherein the reactive metal surface forms the interior surface of a metal-clad autoclave, metallurgical or chemical process vessel, a metal-clad nozzle cover, or a metal-clad reducing flange.

17. The method of claim 1, further comprising resurfacing the reactive metal surface until a repaired reactive metal surface of a thickness of at least 2 millimeters is formed.

18. The method of claim 1, wherein the reactive metal surface is a base metal that is a forged metal product.

19. The method of claim 1, wherein the reactive metal surface is a base metal that is a cast metal product.

20. The method of claim 1, wherein the reactive metal surface is a base metal that is a rolled or wrought metal product.

21. The method of claim 1, further comprising resurfacing an area of 9 inches square or more of the reactive metal surface.

22. The method of claim 1, wherein the particles are sprayed at the reactive metal surface as a cold spray.

23. The method of claim 1, further comprising passing the particles through a converging-diverging nozzle while accelerating.

24. The method of claim 1, wherein the reactive metal surface is heated to a temperature of at least 220 degrees Celsius before contacting with the particles.

25. The method of claim 1, wherein the particles are emitted from the nozzle at a distance of about 40 mm from the reactive metal surface.

26. The method of claim 1, wherein the repaired reactive metal surface is formed to have a porosity of less than 1%.

27. The method of claim 1, wherein the existing reactive metal surface defines a void exposing an underlying different metal, and further comprises contacting the underlying different metal with the accelerated particles to cause the particles to undergo plastic deformation to bond the particles to the underlying different metal to form the repaired reactive metal surface that is continuous with the existing reactive metal surface.

28. The method of claim 1 wherein the particles provided a blocky morphology, the method comprising providing the particles at a feed rate of between about 10 g/min and about 25 g/min, using a gun traverse speed of between about 200 mm/s and about 300 mm/s, preheating the carrier gas to a temperature of between 720 and 950 degrees Celsius, supplying the carrier gas at a pressure of between 3.5 M Pa(g) and 4 M Pa(g), and forming the repaired reactive metal surface with a porosity of less than 1%.

29. The method of claim 1 further comprising applying a wear-resistant ceramic and/or oxide coating on top of the repaired reactive metal surface.

30. The method of claim 29 wherein the wear-resistant ceramic oxide coating comprises Cr₂O₃, TiO₂, or other hard metal oxides.
